(19) United States
(12) Patent Application Publication
(10) Pub. No.: US 2002/0154643 A1
(43) Pub. Date: Oct. 24, 2002

(54) Network communication service control apparatus

(76) Inventors: Shigeki Satomi, Yokohama (JP); Eiji Sonoda, Kawasaki (JP)

Correspondence Address: HOGAN & HARTSON L.L.P., 500 S. GRAND AVENUE, SUITE 1900, LOS ANGELES, CA, 90071-2611, US

(21) Appl. No.: 09/947,588

(22) Filed: Sep. 5, 2001

(30) Foreign Application Priority Data
Apr. 24, 2001 (JP) 2001-125686

(51) Int. Cl. H04L 12/28

(52) U.S. Cl. 370/401; 370/389

(57) ABSTRACT

An information service controlling apparatus distributes service provided by a service provider based on subscriber authentication information that is authenticated by the service provider to multiple users who use the service control apparatus. The information service controlling apparatus includes a data section that contains user authentication information. The information service controlling apparatus performs a control on the use of service by referring to the user authentication information in the data section thereof and rewriting an originating address or a destination address of data packet that is used for transmission and reception of the service. The information service controlling apparatus manages the user authentication information for the users who use the service in association with the data of the service provider to which the information service controlling apparatus subscribes.

### BACKGROUND OF THE INVENTION

1) Field of the Invention

The present invention relates to a method for using a service provided by an application service provider (ASP) who provides application service, and more particularly to a method and apparatus for controlling data between a service provider who needs an authentication system upon providing the service and user terminals of users who use the service.

2) Related Art

When multiple users receive application service from an ASP, a user authentication server initially requests all of the users to provide user authentication data to use the service provided by the ASP. When a user applies for the use of the service from a client (user terminal), the user inputs authentication data and sends the same to the user authentication server (which may be the same as the ASP). In general, when the user authentication server confirms that the authentication data is correct, the service is provided to the client where the use of the service is requested. In this instance, an apparatus and method that act for authenticating the server and the client are required. For example, an authentication proxy apparatus and an authentication proxy method that relay information between the server and the client are required for authenticating both of the server and the client.

A conventional authentication proxy is described in Japanese laid-open patent application HEI 10-1775522. This reference describes a method and apparatus that relay between servers and clients in a server-client system and responds to authentication requests by the servers. According to this reference, once a client is authenticated, the apparatus can act as a proxy for responses concerning the authenticated client to a plurality of servers.

An ASP may obtain many users and can make a profit from charges to the users. Users may generally be divided into two groups. One group is called “small users” where there are many users but the profit per user is small, and the other group is called “large users” where there are few users but the profit per user is large.

In the conventional technology described above, one authentication information at the ASP server is managed in association with one client. Therefore, authentication information for one server cannot be used by a plurality of clients. For example, let us consider one situation where a LAN is installed in a household, such that multiple family members owning their individual personal computers (PCs) can connect to an ASP through the Internet using a common telephone line. When an older brother connects to the ASP to receive the chargeable service, he sends his authentication information to the ASP. When the authentication information is verified, the ASP starts providing its chargeable service. During this time, if a younger brother wants to also receive the chargeable service from the same ASP and the single telephone line is available, the younger brother needs his own authentication information that is different from the older brother's authentication information when sending authentication information to the ASP, although the ASP can connect to an Internet service provider (ISP). If the older brother's authentication information is inputted, a response notifying that the same is already in use is returned, and the young brother cannot connect to the ASP. In other words, when one household defines one subscriber, multiple family members in the household cannot simultaneously receive service with one authentication information. Also, from the viewpoint of the ASP, the cost for managing each individual user results in a fixed cost, and therefore the total management cost for small users becomes substantial, which makes it difficult for the ASP to make a profit.

### SUMMARY OF THE INVENTION

It is an advantage of the present invention to provide a method for controlling use of information service and an apparatus for controlling use of information service that manages data for the use of authentication information by effectively utilizing authentication information at servers.

It is another advantage of the present invention to control the use by multiple small users to thereby create a use environment equivalent to the use by large users, to thereby reduce the management cost per one user by an ASP.

In accordance with one embodiment of the present invention, an apparatus for controlling use of information service may include: a first connection section that is connected to a plurality of user terminals for performing data communication; a communication section that performs data communication with a service provider through the Internet; and a processing section that performs a process including receiving a first data packet that is sent from the user terminal to the service provider for receiving service provided by the service provider, rewriting a first ID of the user terminal at which a user sends the first data packet to a second ID of the apparatus for controlling use of information service, and sending the same to the service provider. In one aspect of the present embodiment, the processing section may perform a process including receiving a second data packet that is sent from the service provider to the second ID, rewriting a forwarding address of the second data packet to the first ID, and sending the second data packet received to the user terminal.

Also, in accordance with one embodiment of the present invention, a method for controlling use of data service may include: receiving service in data packet provided by a service provider connected through the Internet; rewriting a forwarding address of the data packet to an address of a user terminal connected through LAN based on data stored in an area other than a user utility area or a business data area for the data packet; and sending the data packet to the user terminal.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows an overall composition of a system in accordance with one embodiment of the present invention.

FIG. 2 shows a subscriber authentication information table.

FIG. 3 shows a user authentication information table.

FIG. 4 shows a diagram illustrating a communication state until a user terminal receives service provided by a service provider.

FIG. 5 shows a packet structure.

FIG. 6 shows a diagram illustrating a communication state in which multiple users receive service from a service provider and a charge data table.

### PREFERRED EMBODIMENTS OF THE INVENTION

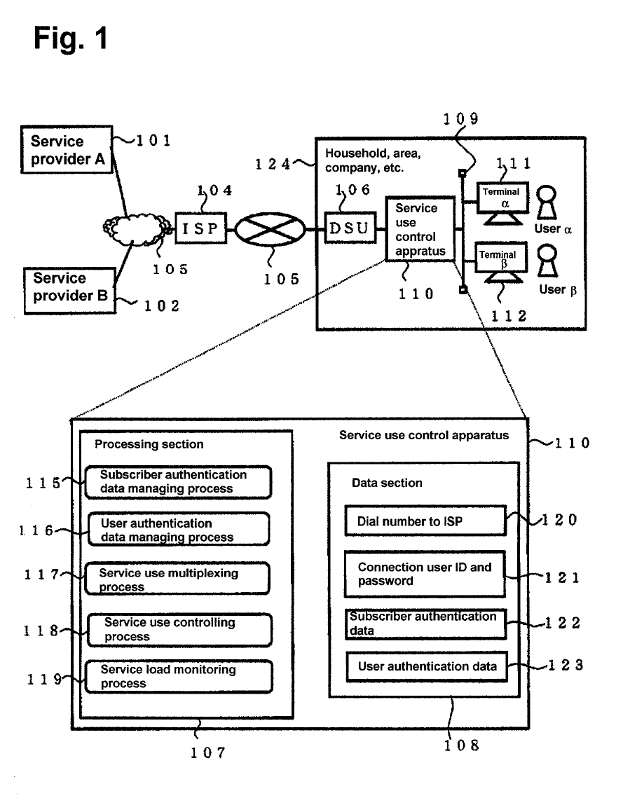

Embodiments of the present invention are described below with reference to the accompanying drawings. FIG. 1 shows an overall structure of a system in accordance with one embodiment of the present invention. A service provider A101, a service provider B102, an Internet service provider (ISP) 104 and a service user apparatus 124 owned by a household, an area, a company or the like who uses a service provided by the service providers are mutually connected through a network 105. The service user apparatus 124 is formed from a digital server unit (DSU) 106, a service use control apparatus (hereafter referred to “service control apparatus) 110 that controls the use of service by users, a LAN 109, a terminal 111 for a user α, and a terminal 112 for a user β. The service control apparatus 110 is connected to the network 105 serving as a carrier for dial-up or the like that connects to the DSU 106 and the LAN 109. It is noted that the terms “service use control” and the terms “information service use control” are interchangeable unless a particular description to discriminate one from the other is provided. Also, for the convenience of description, a network with only two users is described in the present embodiment, but three or more users can be included in the network.

The service control apparatus 110 includes a processing section 107 and a data section 108. The processing section 107 performs a subscriber authentication information managing process 115, a user authentication information managing process 116, a service use multiplexing process 117, a service use controlling process 118, and a service load monitoring process 119. These processes may be performed by a control device that executes programs describing the processes.

The data section 108 stores processing programs (not shown) that describe contents to be executed by the processing section 107, a dial number 120 of the ISP 104, access user ID and password 121 of the service control apparatus 110 that are registered at the ISP 104, subscriber authentication information 122 that describes services usable by the service control apparatus 110 and subscriber IDs and passwords registered for the services, and user authentication information 123 that describes user IDs and passwords that are required when the user 111 and the user 112 want to receive service provided by the service control apparatus 110.

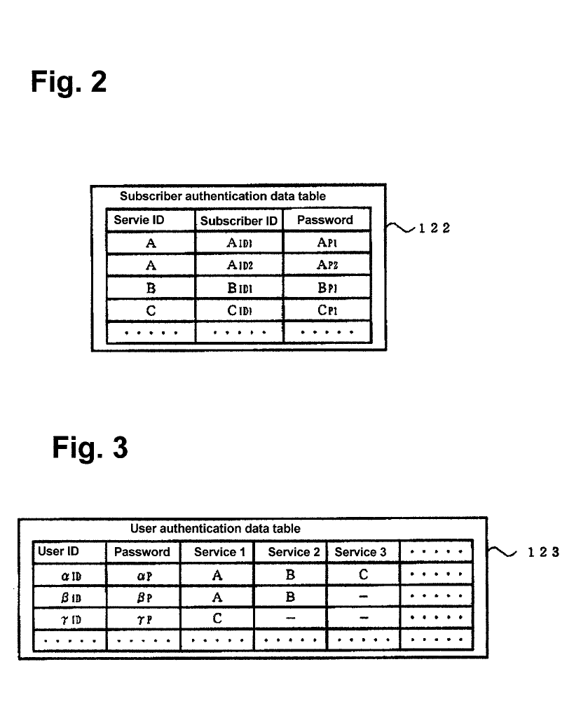

FIG. 2 shows the subscriber authentication information 122. FIG. 3 shows the user authentication information 123. The subscriber authentication information managing process 115 is a process of collectively registering and managing the information shown in FIG. 2 at the data section 108. For example, the subscriber authentication information managing process 115 collectively registers and manages the subscriber authentication information 122 that consists of subscriber IDs and passwords that are accepted by the service provider and service IDs that identify the services. The user authentication information managing process 116 is a process of collectively registering and managing the information shown in FIG. 3 at the data section 108. For example, the user authentication information managing process 116 collectively registers and manages the user authentication information 123 that consists of user IDs and passwords of users who connect to the service control apparatus 110 to use the process performed by the service control apparatus 110, and usable services that discriminate services permitted to be used.

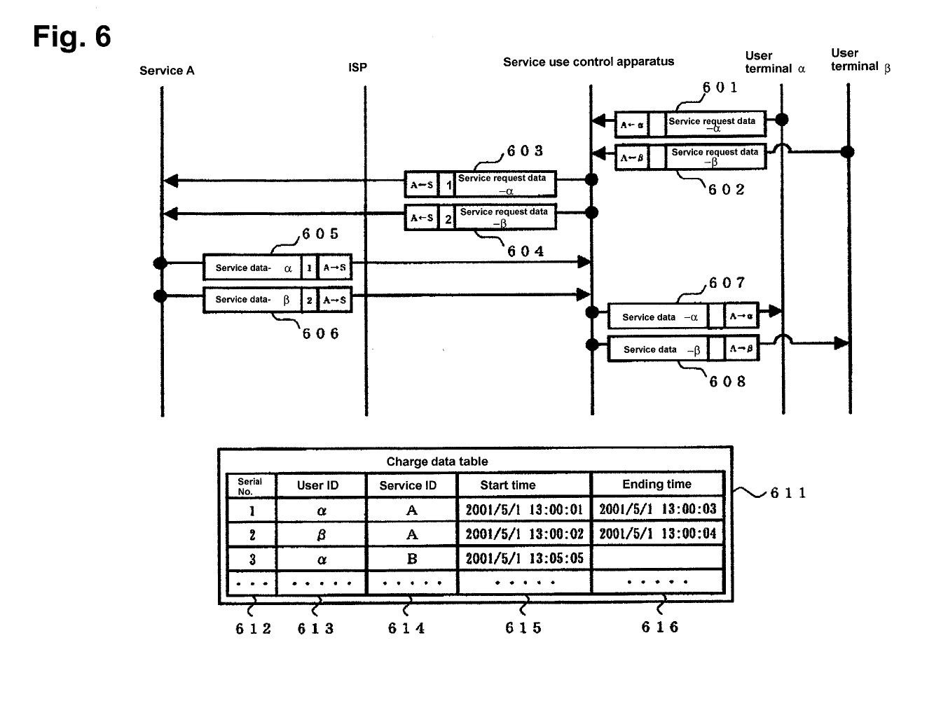

In addition, the data section 108 may store a charge information table that consists of user IDs, service IDs, and use time (see FIG. 6), and use limit data (not shown) that consists of user IDs, service IDs and priority.

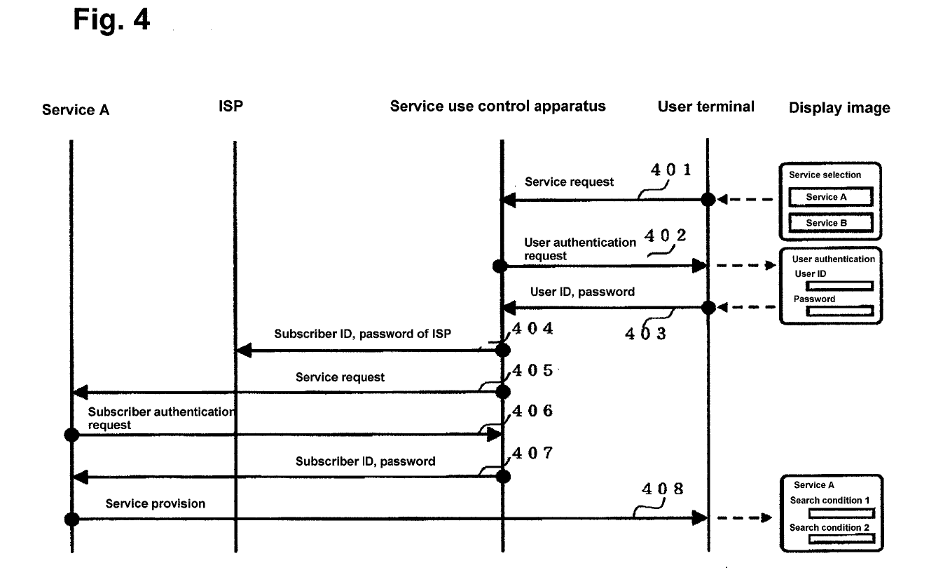

FIG. 4 shows a flow of service that is received by the user at a user terminal. When a service request is made from a user terminal to the service control apparatus 110 (401), the service control apparatus 110 sends a user authentication request for the service control apparatus 110 to the user terminal at which the service request is made (402). The user inputs a user ID and a password and transmits the same to the service control apparatus 110 (403). The service control apparatus 110 refers to the user authentication information 123 in the data section 108 and performs an authentication process to verify if the user who made the service request is registered in the service control apparatus 110. The service control apparatus 110 searches through the data section 108 to check if the user ID and the password are registered, and verifies the user authentication if they are registered. The processes from 401 through 403 are performed as a part of the user authentication information managing process 116. When the user authentication is verified, the service control apparatus 110 refers to the dial number 120 of the ISP and dials up the ISP 104. Then, while referring to the subscriber authentication information in the data section 108, the service control apparatus 110 transmits its own subscriber ID and password to the ISP 104 (404), and connects to the Internet. When connected to the ISP 104, the service control apparatus 110 acts for the user and makes the service request to the service provider (101 or 102) who provides the service requested by the user in step 401 (405). The service provider sends an authentication request to the service control apparatus 110 (406). The service control apparatus 110 refers to the subscriber authentication information 122 in the data section 108, and confirms whether the service control apparatus 110 itself has subscriber IDs and passwords with respect to the service requested by the user. When the service control apparatus 110 itself has the subscriber IDs and passwords, the service control apparatus 110 sends the subscriber IDs and passwords to the service provider (407). When the service provider side accepts the authentication data provided by the service control apparatus 110, the service control apparatus 110 acts for the user to receive the service from the service provider, and provides the received service to the terminal of the user (408). The processes from steps 404 through 407 are performed as a part of the subscriber authentication information managing process 115.

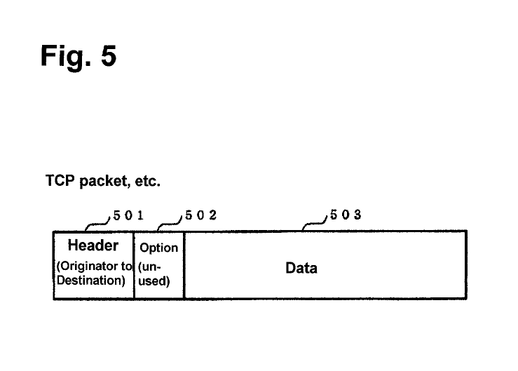

FIG. 5 shows an outline of a packet structure of a TCP packet or the like that is transmitted and received between a user terminal and a service provider through the service control apparatus 110. A header 501 includes a destination address and an originating address. An option 502 is an unused region that is not normally used for communication. Authentication information, service request data and the like are stored in a data region 503. In the embodiment of the present invention, an area in an IP packet or the like other than a user utility area and a business data area is used to add time stamp data, serial number data, and/or user data. Using such data, transmission of data between the service provider and the user terminal is controlled and managed.

FIG. 6 shows a flow of data when multiple users α and β receive the same service from the service provider and a charge data table. The service provider A and the service control apparatus 110 have previously made a subscriber agreement with respect to service A. As a result, the service control apparatus 110 has a subscriber ID and password for receiving the service A, whereby the service provider A has already authenticated the service control apparatus 110. For example, let us assume that an address of the service control apparatus 110 is S, an address of the service provider 101 that provides the service A is A, an address of the terminal 111 of the user α is α, and an address of the terminal 112 of the user β is β. Requests for the service A are made to the service provider A from the terminal 111 of the user α and the terminal 112 of the user β (601). The service control apparatus 110 receives a service request data packet 601 that is sent from the terminal 111 of the user α. In this instance, the header of the packet 601 defines the sender as being α and the destination as being A. Upon receiving the packet 601, the service control apparatus 110 registers a serial number 612, a user ID 613, a service ID 614, and a start time 615 in a charge data table 611. For example, “serial number being 1, user ID being α, service ID being A, start time being 2001/5/1 13:00:01” shown in the charge data table 611 are data that are registered in the charge data table 611 when the service control apparatus 110 receives the packet 601.

The charge data table 611 manages the use status with respect to services that are used by the user. Upon registering the data in the charge data table 611, the service control apparatus 110 adds a serial number 612 (1 in this case) in the option (the region 502 in FIG. 5) of the service request data packet 601, to thereby form a packet 603 in which the originating address α is changed to S, and transmits the packet 603 to the service provider A. It is noted that a user ID may be added to the option region of the packet 603 instead of a serial number to form the packet 603.

Similarly, upon receiving a service request data packet 602 that is sent from the terminal of the user β, the service control apparatus 110 registers a serial number 612, a user ID 613, a service ID 614, and a start time 615 in a charge data table 611. For example, “serial number being 2, user ID being β, service ID being A, start time being 2001/5/1 13:00:02” shown in the charge data table 611 are example data that are registered in the charge data table 611 when the service control apparatus 110 receives the packet 602. Upon registering the data in the charge data table 611, the service control apparatus 110 adds a serial number 612 (“2” in this case) in the option (the region 502 in FIG. 5) of the service request data packet 602 to thereby form a packet 604 in which the originating address β is changed to S, and transmits the packet 604 to the service provider A. In a similar manner as the packet 603, a user ID may be added to the option region of the packet 604 instead of a serial number.

As indicated by the start time 615 of the charge data table 611, the service request issued from the terminal of the user α to the service provider A arrives at the service provider A first. The service provider A forms a service providing data packet 605 for the service request packet 603, which contains “service data—α” written in its data region in response to the request of the user α, and transmits the data packet 605 to the service control apparatus 110 that is a service request originator. Then, when the request issued from the terminal of the user β arrives at the service provider A, the service provider A generates a service providing data packet 606 for the service request packet 604, which contains “service data—β” written in its data region in response to the request of the user β, and transmits the data packet 606 to the service control apparatus 110 that is a service request originator, in a similar manner as performed for the packet 603.

The service control apparatus 110 searches through the charge data table 611 based on the serial numbers written in the option regions of the service providing data packets 605 and 606 that are transmitted from the service provider A, obtains user IDs corresponding to the serial numbers, and registers the times at which the packets are received from the service provider A in ending time sections 616 corresponding to the respective serial numbers in the charge data table 611. Then, the service control apparatus 110 determines addresses for transmission to the user terminals of the respective user IDs, changes the destination address S of the service providing data packets to the addresses of the user terminals (α or β), and deletes the serial numbers added to the option regions. As a result, the packet 605 becomes to be a packet 607 and is sent to the terminal of the user α, and the packet 606 is sent to the terminal of the user β. In this manner, by using one subscriber ID and one password that are assigned to the service control apparatus 110 with respect to the service provider, the service control apparatus 110 intermediates service between the service provider and multiple users such that the service is provided to the multiple users.

From a different viewpoint, the service control apparatus 110 can be considered as a large user of the conventional type. Also, the service control apparatus 110 may have many small users, and controls the use by the small users. The service provider charges to the service control apparatus 110 for the management cost to manage the use of the contracted subscribers. Then, the service control apparatus 110 controls the service, and distributes the cost to the user terminals as the small users. The distribution of the cost may be determined based on the basic contract amount agreed upon between the service control apparatus 110 and the service provider and on service use times stored in the charge data table shown in FIG. 6 on a meter-rate base.

Also, although not described with reference to the drawings, the following process can be performed. A service use amount upper limit for a user who uses the service through the service control apparatus 110 may be registered in the data section of the service control apparatus 110 for control purpose. When a request to use the service is made from a user terminal to the service provider, or at appropriate time intervals even during the use of the service, the service use amount upper limit may be monitored to check whether or not the service use amount upper limit is exceeded. If the amount exceeds the service use amount upper limit that is allocated to the user, the supply of the service from the service provider to the user through the service control apparatus 110 may be controlled to stop. If the amount does not exceed the use amount upper limit, the use of the service may be permitted. Connection time with the service provider, set charge for the amount of chargeable data obtained from the service provider or the like can be used as an index of the use amount upper limit.

Also, the service control apparatus 110 in accordance with the present invention may further register the number of users who use the service and the amount of use in the data section for control purpose. By registering these parameters, a service load monitoring process may be performed such that, when the number of users who use the service increases and the throughput of the service is substantially lowered, the use of the service may be rejected on a priority basis given to users who are subject to the control by the service control apparatus 110.

The embodiments described above provide the following effects. Multiple users can use one subscriber authentication information, and multiple users can simultaneously use the same service. Each of the users does not need to manage a subscriber ID and password for each of the services, but only has to manage his own user ID and password, with the result that the management load of the user can be alleviated.

Furthermore, a service provider only has to manage one subscriber who controls, in effect, an aggregate of n small users. Therefore, for example, the management cost including invoicing for the charge for use, notification and the like can be reduced. It is noted that the number of transmissions of authentication information among the service provider, the service control apparatus and user terminals (n-number of user terminals) may be substantially the same as the number of transmissions of authentication information between the service provider and user terminals (n-number of user terminals) of the conventional system. However, while the transmissions of authentication data in the conventional system are performed through an ordinary communication line, and therefore the communication traffic on the communication network is n when all of the n number of the terminals are connected, the number of transmissions of authentication information using an ordinary communication line in the present invention is reduced to 1/n of the conventional system. As a result, the present invention contributes to the improvement of the utility efficiency of the communication resource.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An information service controlling apparatus comprising:
a connection section connected to a plurality of user terminals for performing data communications;
a communication section that performs data communication with a service provider through the Internet; and
a processing section that receives a first data packet sent from a first one of the plurality of user terminals to the service provider for receiving service provided by the service provider, rewrites a sender address assigned to the first one of the plurality of user terminals which sends the first data packet to another address assigned to the information service controlling apparatus, and sends the first data packet to the service provider.

2. An information service controlling apparatus according to claim 1, wherein the processing section further includes a process that receives a second data packet sent from the service provider to the second ID, rewrites a forwarding address described in the second data packet to the first ID, and sends the second data packet to the first one of the user terminals.

3. An information service controlling apparatus according to claim 2, further comprising a data section that stores subscriber IDs and passwords for the service provider, wherein the processing section performs a process of responding to an authentication request from the service provider using the subscriber IDs.

4. An information service controlling apparatus according to claim 3, wherein the data section stores data for user terminals that are permitted to connect to the service provider.

5. An information service controlling apparatus according to claim 2, wherein, when the processing section receives a service request from a third ID of another of the plurality of user terminals while data packets are exchanged between the first ID and the service provider, the processing section does not perform a subscriber authentication process that uses the subscriber IDs and passwords.

6. An information service controlling apparatus according to claim 3, wherein, when the processing section receives a service request from a third ID of another of the user terminals while data packets are exchanged between the first ID and the service provider, the processing section does not perform a subscriber authentication process that uses the subscriber IDs and passwords.

7. An information service controlling method comprising:
receiving service in a data packet provided by a service provider connected through the Internet;
rewriting a forwarding address S of the data packet to a user address α of a user terminal connected through a LAN based on a serial number or user ID data indicated in a region other than a user utility region or a business data region of the data packet; and
sending the data packet to the user terminal at the user address α.

8. An information service controlling method according to claim 7, further comprising the steps of:
receiving a service request data packet that is sent through the LAN from the user terminal at the user address α to the service provider for receiving service provided by the service provider;
determining if at least a user ID for the user terminal at the user address α is registered of a member who is using the information service control method;
when the user ID for the user terminal is registered, rewriting the user address α of the user terminal described in the service request data packet to the address S.

9. An information service controlling method according to claim 8, further comprising the step of sending the service request data packet containing the address S as a sender address to the service provider through the Internet.

10. An information service controlling method according to claim 7, before the rewriting step, the method further comprises the steps of receiving an authentication request from the service provider, determining if at least a subscriber ID is registered at the address S, and sending at least the subscriber ID to the service provider.

11. An information service controlling method according to claim 10, further comprising the steps of:
receiving a service request data packet that is sent through the LAN from the user terminal having user address α to the service provider for receiving service provided by the service provider;
determining if at least a user ID for using a service from the service provider is registered at the address S that is different from the first address;
when the user ID is registered at the address S, rewriting the user address α of the user terminal described in the service request data packet to the address S;
receiving an authentication request from the service provider; and
determining if at least a subscriber ID for receiving a service from the service provider is registered at the address S, and sending at least the subscriber ID to the service provider when at least the subscriber ID is registered at the address S.

12. An information service controlling method according to claim 10, further comprising the steps of storing subscriber IDs and passwords for a plurality of user terminals, and responding to an authentication request sent from the service provider using the subscriber IDs.

13. An information service controlling method according to claim 12, further comprising the steps of receiving a service request data packet that is sent through the LAN from another terminal having a third address for receiving service provided by the service provider; and restricting the use of data service by the other terminal having the third address if data packets are currently exchanged between the user terminal at the address α and the service provider.

14. An information service controlling method comprising the steps of:
receiving by a communication service control apparatus a first data packet that is sent from a first user terminal to a service provider for receiving service provided by the service provider;
rewriting a first ID described in the first data packet that is assigned to the first user terminal to a second ID assigned to the communication service control apparatus, and sending the first data packet to the service provider;
receiving a second data packet that is sent from the service provider to the second ID; and
rewriting a forwarding address of the second data packet from the second ID to the first ID, and sending the second data packet to the first user terminal.

15. An information service controlling method according to claim 14, further comprising the steps of, after receiving the first data packet, determining if at least a user ID for the first user terminal is registered in the communication service control apparatus, and connecting to the service provider if the user ID for the first user terminal is registered in the communication service control apparatus.

16. An information service controlling method according to claim 14, further comprising the steps of receiving an authentication request from the service provider, determining if at least a subscriber ID for the first user terminal is registered in the communication service control apparatus, and sending at least the subscriber ID for the user terminal to the service provider when at least the subscriber ID for the user terminal is registered at the communication service control apparatus.

17. An information service controlling method according to claim 14, further comprising the steps of:
after receiving the first data packet, determining if at least a user ID for the first user terminal is registered in the communication service control apparatus, and connecting to the service provider if the user ID for the first user terminal is registered in the communication service control apparatus;
receiving an authentication request from the service provider;
determining if at least a subscriber ID for the first user terminal is registered in the communication service control apparatus; and
sending at least the subscriber ID for the user terminal to the service provider when at least the subscriber ID for the user terminal is registered at the communication service control apparatus.

18. An information service controlling method according to claim 14, further comprising the steps of storing subscriber IDs and passwords for a plurality of users, and responding to an authentication request sent from the service provider using the subscriber IDs.

19. An information service controlling method according to claim 14, further comprising the step of, when a service request is received from a third ID of another user terminal while data packets are exchanged between the first user terminal at the first ID and the service provider, prohibiting a subscriber authentication process for the third ID using the subscriber IDs and passwords.

20. An information service controlling method according to claim 15, further comprising the step of receiving a service request from another user terminal and prohibiting a subscriber authentication process for the third ID using the subscriber IDs and passwords until sending the second packet to the first user terminal which sent the request data.
